(19) United States
(12) Patent Application Publication
(10) Pub. No.: US 2022/0331834 A1
(43) Pub. Date: Oct. 20, 2022

(54) DISPENSE TIPS AND METHODS OF MANUFACTURING THE SAME

(71) Applicant: NORDSON CORPORATION, WESTLAKE, OH (US)

(72) Inventors: Robert W. SPRINGHORN, Cream Ridge, NJ (US); Robert CARVALHO, Bristol, RI (US); William MACINDOE, East Providence, RI (US)

(21) Appl. No.: 17/631,585

(22) PCT Filed: Jul. 29, 2020
(86) PCT No.: PCT/US2020/043941

§ 371 Date: Jan. 31, 2022

Related U.S. Application Data
(60) Provisional application No. 62/882,084, filed on Aug. 2, 2019.

(51) Int. Cl. B05C 17/005

(52) U.S. Cl. CPC B05C 17/00513; B05C 17/00593

(57) ABSTRACT

A dispense tip receives material from a material source and applies the material to a substrate. The dispense tip includes a hub having a body that defines a proximal end, a distal end opposite the proximal end along a central axis, a passage extending through the body, an inner surface facing the passage, and at least three radial features each extending 360 degrees about the central axis and radially into the body from the inner surface. The dispense tip also includes a tube defining a central passage extending therethrough, where the tube is at least partially received within the passage such that the central passage of the tube is in fluid communication with the passage, and an adhesive is disposed between the tube and the inner surface of the hub. The adhesive is received within the at least three radial features and secures the tube to the hub.

### CROSS-REFERENCE TO RELATED APPLICATIONS

This application is a National Stage Application of International Patent App. No. PCT/US2020/043941, filed Jul. 29, 2020, which claims the benefit of U.S. Provisional Patent App. No. 62/882,084, filed Aug. 2, 2019, the entire disclosures of both of which are hereby incorporated by reference as if set forth in their entirety herein.

### TECHNICAL FIELD

This application generally relates to dispense tips for receiving a material from a material source and applying the material to a substrate, and, more particularly, to dispense tips including a hub and a tube secured to the hub with adhesive.

### BACKGROUND

In many material applications, such as the application of adhesive, it is necessary to precisely apply the material to a substrate. This precise application can be performed using a dispense tip, where such dispense tips commonly include a hub configured to interface with the material source and a tube configured to allow for precise application of the material to the substrate. Conventionally, such a hub and dispense tip can be coupled to each other using various types of adhesives. As one of the hub and the tube can be comprised of metal, it is desirable that such dispense tips be reusable. In order to allow for reusability, dispense tips must be flushed with a cleaning solvent between uses so as to prevent contamination of any subsequently used adhesive. However, over time cleaning solvents can begin to damage the adhesive joining the hub and the tube, which can cause the tube and hub to prematurely separate, thus rendering the dispense tip inoperable. Additionally, the bond created by the adhesive between the hub and the tube can be inherently weak, which can lead to separation of the tub from the hub during normal dispensing operations.

As a result, there is a need for a dispense tip comprised of a hub and a tube joined by adhesive that can withstand multiple dispensing and cleaning operations.

### SUMMARY

An embodiment of the present disclosure is a dispense tip configured to receive material from a material source and apply the material to a substrate. The dispense tip includes a hub having a body that defines a proximal end, a distal end opposite the proximal end along a central axis, a passage extending through the body from the proximal end to the distal end, an inner surface facing the passage, and at least three radial features each extending at least partially about the central axis. The dispense tip also includes a tube defining a central passage extending therethrough, where the tube is configured to be at least partially received within the passage such that the central passage of the tube is in fluid communication with the passage of the hub, and an adhesive disposed between the tube and the inner surface of the hub, wherein the adhesive is received within the at least three radial features and is configured to secure the tube to the hub.

Another embodiment of the present disclosure is a method of manufacturing a dispense tip configured to receive material from a material source and apply the material to a substrate. The method includes providing a hub having a body that defines a proximal end, a distal end opposite the proximal end along a central axis, a passage extending through the body from the proximal end to the distal end, an inner surface facing the passage, and at least three radial features each extending at least partially about the central axis. The method also includes placing a tube defining a central passage extending therethrough at least partially within the passage such that the central passage of the tube is in fluid communication with the passage of the hub, and applying an adhesive within the passage of the hub between the tube and the inner surface of the hub to secure the tube to the hub.

### BRIEF DESCRIPTION OF THE DRAWINGS

The foregoing summary, as well as the following detailed description, will be better understood when read in conjunction with the appended drawings. The drawings show illustrative embodiments of the disclosure. It should be understood, however, that the application is not limited to the precise arrangements and instrumentalities shown.

FIG. 1 illustrates a perspective view of a dispense tip according to an embodiment of the present disclosure;

FIG. 2 illustrates a cross-sectional view of the dispense tip shown in FIG. 1, taken along line 2-2 in FIG. 1;

FIG. 3A illustrates an enlarged portion of the cross-sectional view shown in FIG. 2;

FIG. 3B illustrates an enlarged portion of the cross-sectional view shown in FIG. 3A;

FIG. 3C illustrates an enlarged portion of a cross-sectional view of an alternatively configured hub usable in the dispense tip shown in FIG. 1;

FIG. 3D illustrates an enlarged portion of a cross-sectional view of a further alternatively configured hub usable in the dispense tip shown in FIG. 1;

FIG. 3E illustrates an enlarged portion of a cross-sectional view of an additional alternatively configured hub usable in the dispense tip shown in FIG. 1;

FIG. 4 illustrates a perspective view of a dispense tip according to another embodiment of the present disclosure;

FIG. 5 illustrates a cross-sectional view of the dispense tip shown in FIG. 4, taken along line 5-5 in FIG. 4;

FIG. 6 illustrates an enlarged portion of the cross-sectional view shown in FIG. 5;

FIG. 7 illustrates a perspective view of a dispense tip according to another embodiment of the present disclosure;

FIG. 8 illustrates a cross-sectional view of the dispense tip shown in FIG. 7, taken along line 8-8 in FIG. 7;

FIG. 9 illustrates a partial cross-sectional view of the dispense tip shown in FIG. 7; and

FIG. 10 illustrates a process flow diagram of a method of manufacturing a dispense tip according to an embodiment of the present disclosure.

### DETAILED DESCRIPTION OF ILLUSTRATIVE EMBODIMENTS

Described herein are dispense tips 10, 100, 200 that that include a hub 20, 20′, 20″, 20′″, 120, 220 coupled to a tube 50, 150, 250 using adhesive. Certain terminology is used to describe the dispense tips 10, 100, 200 in the following description for convenience only and is not limiting. The words “right”, “left”, “lower,” and “upper” designate directions in the drawings to which reference is made. The words “inner” and “outer” refer to directions toward and away from, respectively, the geometric center of the description along the radial direction R to describe the dispense tips 10, 100, 200 and related parts thereof. The terminology includes the above-listed words, derivatives thereof and words of similar import. Unless otherwise specified herein, the terms “axial,” and “radial” are used to describe the directional components of various components of the dispense tips 10, 100, 200, as designated by the axial direction A and radial direction R. It should be appreciated that while the axial direction A is shown as extending along a certain plane and the radial direction R is shown in a particular orientation relative to the axial direction A, the radial direction R can extend in any direction along a plane normal to the axial direction A.

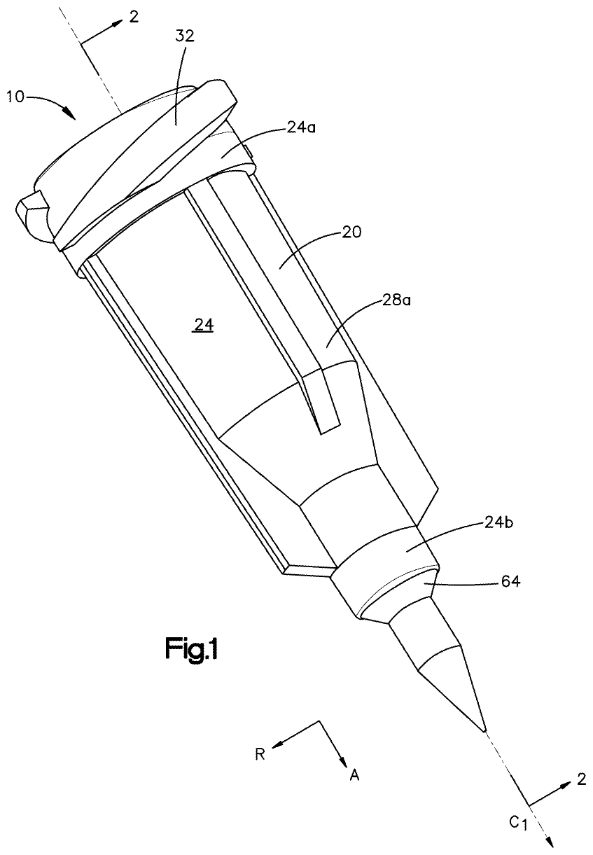

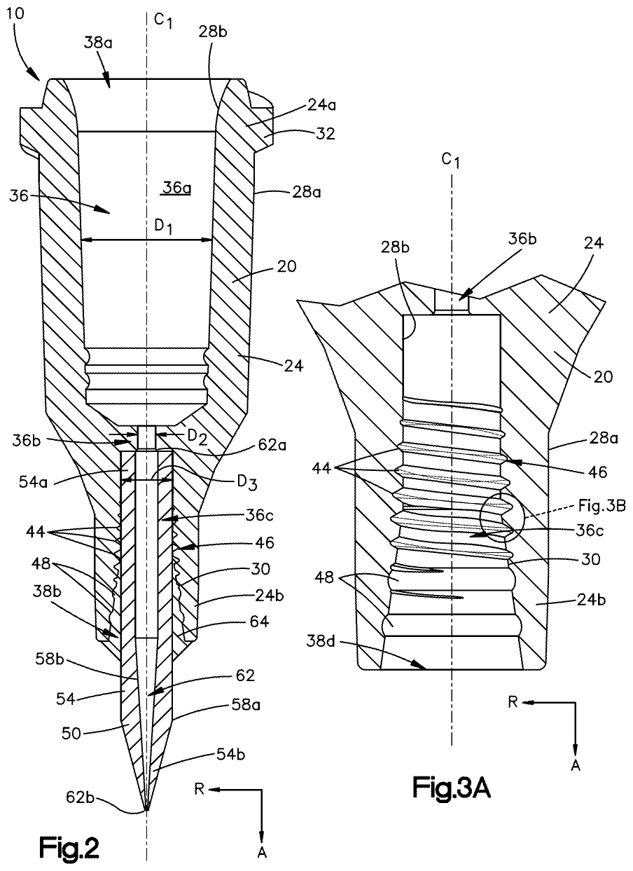

Referring to FIGS. 1-3B, a dispense tip 10 according to an embodiment of the present disclosure will be described. The dispense tip 10 can be configured to receive material from a material source and apply the material to a substrate, as will be described further below. The dispense tip 10 can include a hub 20 and a tube 50 secured to the hub 20 using adhesive 64, where each of the hub 20, tube 50, and adhesive 64 will be described in detail below. The hub 20 can comprise a body 24 that defines a proximal end 24a and a distal end 24b opposite the proximal end 24a along a central axis C₁ that is parallel to the axial direction A. The central axis C₁ can extend through the body 24 such that the central axis C₁ extends through the radial center of the body 24. The hub 20 can be comprised of a plastic, such as polypropylene, polyethylene, PEEK, etc. The hub 20 can also be comprised of a metal, such as stainless steel, though other metals are also contemplated. The body 24 can also define an outer surface 28a, and an inner surface 28b opposite the outer surface 28a along the radial direction R. The body 24 can include a thread 32 extending radially from the outer surface 28a of the body 24. The thread 32 can be configured to threadedly engage a material source (not shown), such as a dispensing valve, dispensing pump, dispensing reservoir such as a barrel syringe, etc. Though thread 32 specifically is shown, the body 24 can include alternative means for engaging with the material source, such as snap-fit engagement, slot and groove attachment, bayonet attachment, etc.

The body 24 can further include a passage 36 extending through the body 24 from the proximal end 24a to the distal end 24b, such that the inner surface 28b faces the passage 36. The passage 36 can extend from an inlet 38a at the proximal end 24a of the body 24 to an outlet 38d at the distal end 24b of the body 24. The passage 36 can define multiple sections, particularly a first section 36a at the proximal end 24a of the body 24, third section 36c at the distal end 24b of the body 24, and a second section 36b that extends from the first section 36a to the third section 36c along the axial direction A. The first section 36a of the passage 36 can define a first diameter D₁ measured along the radial direction R, the second section 36b can define a second diameter D₂ measured along the radial direction R, and the third section 36c can define a third diameter D₃ measured along the radial direction R. As depicted, the first diameter D₁ is greater than the second and third diameters D₂, D₃, and the third diameter D₃ is less than the first and second diameters D₁, D₂. As such, the second diameter D₂ is less than the first and third diameters D₁, D₃.

A portion 30 of the inner surface 28b that faces the third section 36c of the passage 36 can taper radially outwards as it extends downwards along the axial direction A. As depicted, this taper can be substantially linear along the axial direction A, such that the portion 30 of the inner surface 28b forms a truncated cone with sides that define an angle Θ₁ with respect to the central axis C₁. The angle Θ₁ can be from about 5 degrees to about 15 degrees, though other ranges for the angle Θ₁ are contemplated. The portion 30 can be tapered as such to provide space for the hub 20 to receive the adhesive 64, as will be described further below.

The body 24 of the hub 20 can also define at least three implementations of the first radial features 44 and second radial features 48 extending radially into the body 24 from the inner surface 28b. As such, the first radial features 44 and the second radial features 48 can be recesses that extend into the body 24. Each of the first radial features 44 and the second radial features 48 can extend at least partially, such as 360 degrees, about the central axis C₁ and radially into the body 24 from the inner surface 28b. Collectively, the hub 20 can define one, two, three, four, five, or six or more of the first radial features 44 and the second radial features 48. The depicted hub 20 can include at least one implementation of the first radial feature 44 and at least one implementation of the second radial feature 48, where each of the first radial features 44 and the second radial features 48 will be discussed in turn. In the depicted embodiment, each of the first radial features 44 can define a portion of a thread 46 that extends substantially continuously and helically along the inner surface 28b of the hub 20 through a portion of the third section 36c of the passage 36. Specifically, each of the first radial features 44 can define a portion of the thread 46 that extends 360 degrees about the central axis C₁. As a result, the thread 46 can comprise one, two, three, four, five, six, seven, eight, or nine or more individual implementations of the first radial features 44.

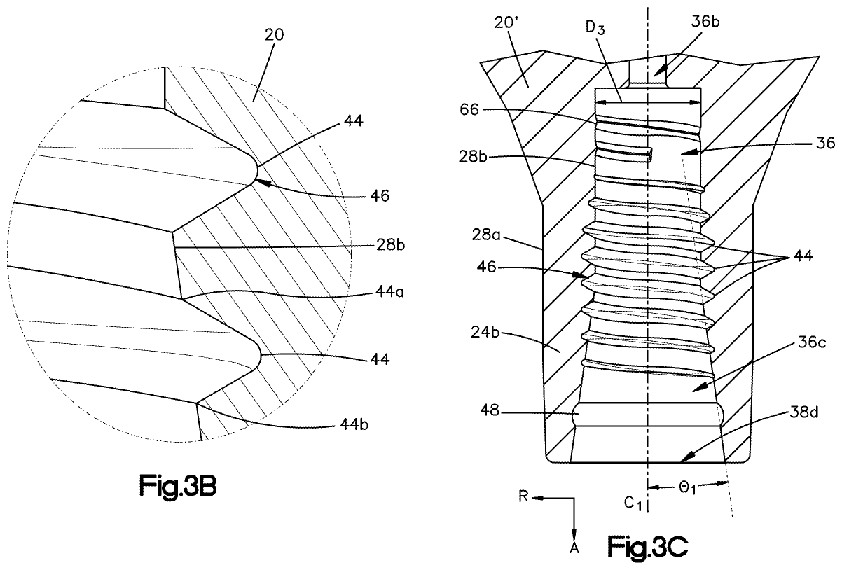

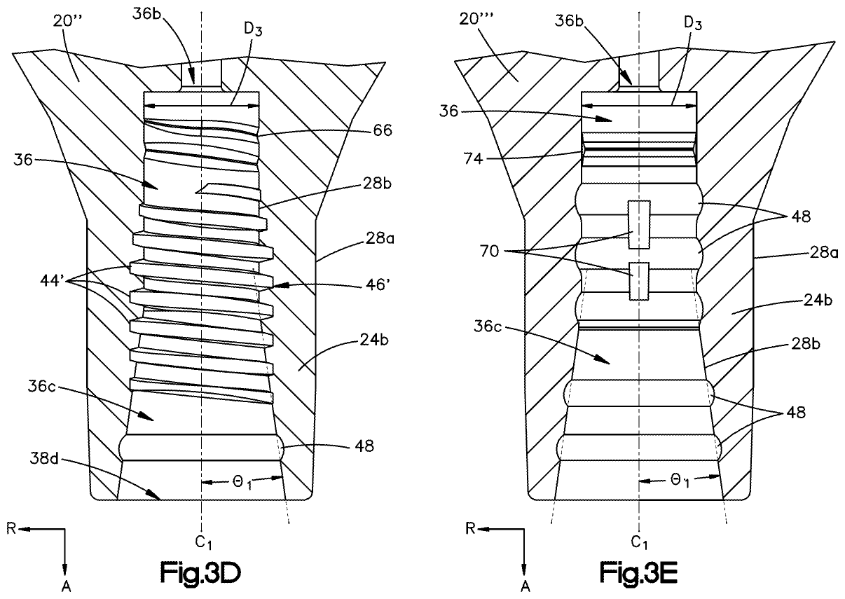

As shown in FIG. 3A, the first radial features 44 can have different heights along the central axis C₁. For example, the height of the proximal and distal end of the first radial features 44 can be less than the height of the first radial features 44 in between the proximal and distal ends of the hub 20. As such, the height of the first radial features 44 first increases, reaches a maximum, and then decreases from the proximal end to the distal end and from the distal end to the proximal end of the hub 20.

Each of the first radial features 44 can have a triangular profile along a plane parallel to the central axis C₁, though other profiles are contemplated. The thread 46, and thus the first radial features 44, can be positioned on the inner surface 28b at any location within the third section 36c of the inner surface 28b as desired. As shown in FIG. 3B, each of the first radial features 44 can extend from an upper edge 44a defined at the proximal end of the first radial feature 44 to a lower edge 44b defined at the distal end of the first radial feature 44. Each of the upper edge 44a and the lower edge 44b can define sharp cutouts that define the bounds of each first radial feature 44 and the locations at which the first radial features 44 extend from the inner surface 28b.

The body 24 of the hub 20 can further define at least one implementation of the second radial feature 48 that extends along a respective plane that is normal to the central axis C₁. As such, each of the second radial features 48 can substantially define a ring-shaped recess that extends 360 degrees about the central axis C₁. Though depicted as including two of the second radial features 48, the body 24 can define more or less than two of the second radial features 48. For example, the body 24 can define one, two, three, or four or more implementations of the second radial features 48. Further, as depicted the thread 46 defined by the first radial features 44 and at least one of the second radial features 48 can at least partially overlap along the axial direction A. However, it is contemplated that in other embodiments each of the first radial features 44 can be spaced from the second radial features 48 along the axial direction A. As shown, the body 24 of the hub 20 can include at least one of the second radial features 48 that extends along a respective plane that is normal to the central axis C₁, as well as at least one of the first radial features 44 that partially defines a thread 46, which may be a continuous helical thread. In other embodiments, it is contemplated that the hub 20 can include a plurality of only one of the first radial features 44 or the second radial features 48.

The dispense tip 10 can further include a tube 50 configured to be at least partially received within the passage 36 of the hub 20. The tube 50 can have a body 54 that defines a proximal end 54a and a distal end 54b opposite the proximal end 54a along the axial direction A. The body 54 can be comprised of a plastic, such as polypropylene, metal, such as stainless steel or a powdered metal, ceramic, such as zirconia toughened alumina, zirconia, silicon nitride, etc. The body 54 can also define an outer surface 58a and an inner surface 58b opposite the outer surface 58a along the radial direction R. As shown, the tube 50 can be substantially shaped as a cylindrical tube along its length with the exception of the distal end 54b, which can taper inwards so as to define a point. However, it is contemplated that the tube 50 can be tapered more or less at the distal end 54b in other embodiments, or can even define a completely non-tapered cylindrical tube. The tube 50 can define a central passage 62 extending therethrough from an inlet 62a at the proximal end 54a to an outlet 62b opposite the inlet 62a along the axial direction A at the distal end 54b. When the tube 50 is received within the passage 36, particularly the third section 36c of the passage 36, the central passage 62 of the tube 50 is in fluid communication with the passage 36 of the hub 20, such that when the dispense tip 10 is attached to a material source, the material can flow from the material source, through the inlet 38a of the passage 36, through the first section 36a and the second section 36b of the passage 36, through the inlet 62a of the central passage 62 of the tube 50, through the central passage 62 of the tube 50, and out the outlet 62b of the central passage 62 and onto a substrate.

During assembly, the hub 20 and the tube 50 must be joined together so that the tube 50 does not separate from the hub 20 during use. To do this, adhesive 64 can be disposed between the outer surface 58a of the tube 50 and the inner surface 28b of the hub 20 to secure the tube 50 to the hub 20. The adhesive 64 can be a two-part epoxy, though other types of adhesives are contemplated. In previous dispense tip embodiments, the bond between the hub and the tube created by the adhesive can weaken over time, leading to material leaking out of the dispense tip or the tube completely separating from the hub. However, in the dispense tip 10, the presence of the first radial features 44 and the second radial features 48 can strengthen the ability of the adhesive 64 to bond the hub 20 to the tube 50. Specifically, when the adhesive 64 is disposed between the tube 50 and the hub 20, the adhesive is received within each of the first radial features 44 and the second radial features 48. This allows the adhesive 64 to create a stronger grip with the hub 20, thus creating a stronger bond between the tube 50 and the hub 20. Over time, dispense tips 10 including the first radial features 44 and the second radial features 48 are able to withstand greater relative loads applied to one of the hub 20 and the tube 50 and undergo a greater number of cleaning cycles without the bond between the hub 20 and the tube 50 weakening or completely failing.

Now referring to FIG. 3C, another embodiment of a hub 20′ that can comprise part of the dispense tip 10 will be described. As many features of the hub 20′ are similar to that of the hub 20, such features will be identically labelled in the drawings and not described here for brevity. Like the hub 20, the hub 20′ can define at least three first and second radial features 44, 48 extending radially into the body 24 from the inner surface 28b. However, the hub 20′ can define only one of the second radial features 48, while still defining a plurality of the first radial features 44 that comprise a continuous helical thread 46. Additionally, the hub 20′ can define a protrusion 66 extending into the passage 36 from the inner surface 38b of the hub 20′. The protrusion 66 can be positioned within the third section 36c of the passage 36 between the proximal end 24a of the body and the first and second radial features 44, 48 along the axial direction A. Specifically, the protrusion 66 is positioned distal to the second section 36b of the passage 36 and the inlet 62a of the tube 50. The protrusion 66 can extend along the inner surface 28b at least 360 degrees about the central axis C₁. The protrusion 66 can define a cross-sectional profile along a plane that is parallel to the central axis C₁ that is substantially triangular. However, the protrusion 66 can define differently shaped profiles as desired.

In the hub 20′, the protrusion 66 can define a helical thread that extends along the inner surface 28b of the body 24. As such, the protrusion 66 can extend more than 360 degrees about the central axis C₁. For example, the protrusion 66 can extend at least 450 degrees along the inner surface 28b about the central axis C₁, at least 540 degrees, at least 630 degrees, at least 720 degrees, etc. During the assembly of a dispense tip, when adhesive is disposed between the tube and the hub, the adhesive can collect and harden in the vicinity of the inlet of the tube, thus creating an obstruction to the flow of material from the hub and into the tube. The presence of the protrusion 66 can limit the upward movement of the adhesive 64 between the tube 50 and the hub 20′ while ventilating trapped air, thus preventing adhesive 64 from reaching the inlet 62a of the tube 50 and affecting the flow of material through from the hub 20′ to the tube 50 in any capacity.

Now referring to FIG. 3D, another embodiment of a hub 20″ that can comprise part of the dispense tip 10 will be described. As many features of the hub 20″ are similar to that of the hubs 20, 20′, such features will be identically labelled in the drawings and not described here for brevity. Like the hubs 20, 20′, the hub 20″ can define at least three implementations of the first radial features 44′ and second radial features 48 extending radially into the body 24 from the inner surface 28b. Like the hub 20′, the hub 20″ can define only one of the second radial features 48, while still defining a plurality of the first radial features 44′ that comprise a continuous helical thread 46′. However, unlike the hubs 20, 20′, each of the first radial features 44′ of the hub 20″ can have a trapezoidal profile along a plane parallel to the central axis C₁. As such, the thread 46′ can comprise a trapezoidal thread such as an ACME thread, though the thread 46′ can comprise other types of trapezoidal threads as desired.

Referring to FIG. 3E, a further embodiment of a hub 20′″ that can comprise part of the dispense tip 10 will be described. As many features of the hub 20′″ are similar to that of the hubs 20, 20′, 20″, such features will be identically labeled in the drawings and not described here for brevity. Unlike the hubs 20, 20′, 20″, the hub 20′″ can include at least three of the second radial features 48. As described previously, each of the second radial features 48 can extend along a respective plane that is normal to the central axis C₁. As such, each of the second radial features 48 can substantially define a ring-shaped recess that extends 360 degrees about the central axis C₁. The hub 20′″ is depicted as including five second radial features 48. However, in other embodiments the hub 20′″ can include one, two, three, four, six, seven, or eight or more of the second radial features 48.

Unlike the hubs 20, 20′, 20″, the hub 20′″ can define at least one implementation of a groove 70 that extends radially into the body 24 from the inner surface 28b and along the axial direction A. The grooves 70 can extend from one of the second radial features 48 to another of the second radial features 48. In the depicted embodiment of hub 20′″, the hub 20′″ includes two grooves 70, each of which can extend from one of the second radial features 48 to another of the second radial features 48. As shown, the groove 70 can have a substantially rectangular profile, and can extend substantially along the axial direction A. However, it is contemplated that the groove 70 can extend in other directions and have differently shaped profiles. Further, the hub 20′″ can include more or less than two grooves 70, each extending between different combinations of the second radial features 48, or include some of the grooves 70 extending between the same implementation of the second radial features 48. When assembling the dispense tip 10, the adhesive 64 is applied within the passage 36 after the tube 50 has been at least partially received within the passage 36. In certain instances it can be difficult to ensure that adhesive 64 fills the entirety of the remaining space along the axial direction A within the passage 36 and engages each of the first radial features 44, 44′, and the same second radial features 48. The inclusion of the groove 70 can help ease flow of the adhesive 64 between each of the second radial features 48. Though shown solely as defined with respect to the second radial features 48, the grooves 70 can extend between two of any of the first radial features 44, 44′ or second radial features 48.

The hub 20′″ can also define a protrusion 66′ extending into the passage 36 from the inner surface 38b of the hub 20′″. Like the protrusion 66, the protrusion 66′ can be positioned within the third section 36c of the passage 36 and can extend along the inner surface 28b at least 360 degrees about the central axis C₁. Further, the protrusion 66′ can define a cross-sectional profile along a plane that is parallel to the central axis C₁ that is substantially triangular. However, the protrusion 66′ can define differently shaped profiles as desired. Unlike the protrusion 66, the protrusion 66′ of the hub 20′″ can extend along a plane that is normal to the central axis C₁. As such, the protrusion 66′ can have a substantially ring-like shape. Further, though one protrusion 66′ is shown, the hub 20′″ can include more protrusions 66′ in other embodiments. The hub 20′″ can further define at least one implementation of a groove 74 that extends through the protrusion 66′ and along the axial direction A. In the depicted embodiment of hub 20′″, the hub 20′″ includes two grooves 74, each of which can extend through the protrusion 66′ along the axial direction A. The two grooves 74 are shown as positioned on substantially opposite sides of the passage 36, though other positions for the grooves 74 are contemplated. Further, the hub 20′″ can include more or less than two grooves 74, such as one, two, three, four, or five or more grooves 74. While the protrusion 66′ can function to prevent adhesive from flowing near the inlet 62a of the tube 50, the grooves 74 extending through the protrusion 66′ can allow air to escape from below the protrusion 66′ when the tube 50 or the adhesive 64 is being disposed within the passage 36. This prevents air from being entrapped between the tube 50 and the hub 20′″ or within the adhesive 64, thus allowing for a more secure engagement between the hub 20′″ and the tube 50.

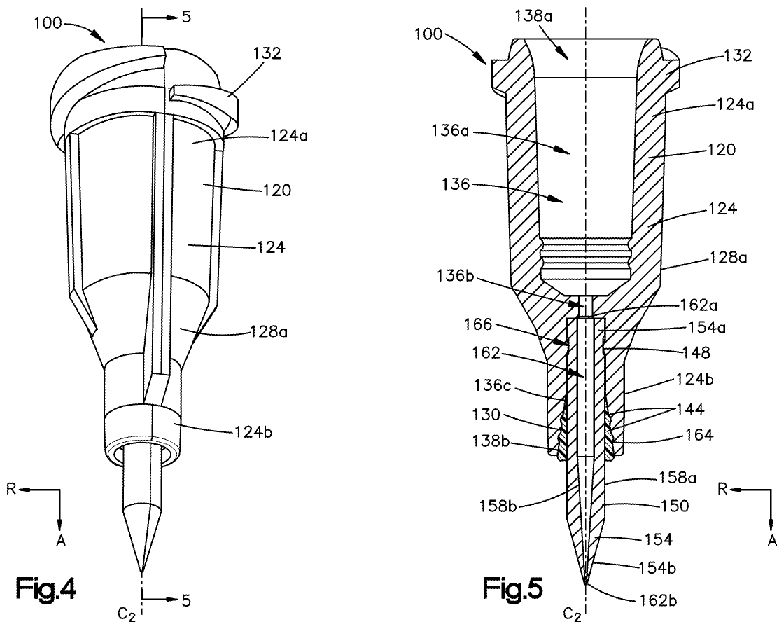

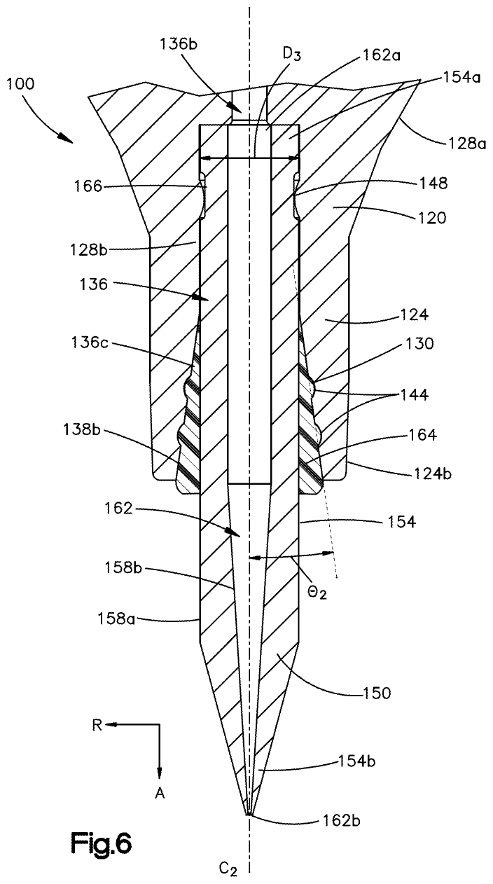

Now referring to FIGS. 4-6, a dispense tip 100 according to another embodiment of the present disclosure will be discussed. The dispense tip 100 can be configured to receive material from a material source and apply the material to a substrate, as will be described further below. The dispense tip 100 can include a hub 120 and a tube 150 secured to the hub 120 using adhesive 164, where each of the hub 120, tube 150, and adhesive 164 will be described in detail below. The hub 120 can comprise a body 124 that defines a proximal end 124a and a distal end 124b opposite the proximal end 124a along a central axis C₂ that is parallel to the axial direction A. The central axis C₂ can extend through the body 124 such that the central axis C₂ extends through the radial center of the body 124. The hub 120 can be comprised of a plastic, such as polypropylene, polyethylene, PEEK, etc. The hub 120 can also be comprised of a metal, such as stainless steel, though other metals are also contemplated. The body 124 can also define an outer surface 128a, and an inner surface 128b opposite the outer surface 128a along the radial direction R. The body 124 can include a thread 132 extending radially from the outer surface 128a of the body 124. The thread 132 can be configured to threadedly engage a material source, such as a dispensing valve, dispensing pump, dispensing reservoir such as a barrel syringe, etc. Though thread 132 specifically is shown, the body 124 can include alternative means for engaging with a material source (not shown), such as snap-fit engagement, slot and groove attachment, bayonet attachment, etc.

The body 124 can further include a passage 136 extending through the body 124 from the proximal end 124a to the distal end 124b, such that the inner surface 128b faces the passage 136. The passage 136 can extend from an inlet 138a at the proximal end 124a of the body 124 to an outlet at the distal end 124b of the body 124. The passage 136 can define multiple sections, particularly a first section 136a at the proximal end 124a of the body 124, third section 136c at the distal end 124b of the body 124, and a second section 136b that extends from the first section 136a to the third section 136c along the axial direction A.

A portion 130 of the inner surface 128b that faces the third section 136c of the passage 136 can taper radially outwards as it extends downwards along the axial direction A. As depicted, this taper can be substantially linear along the axial direction A, such that the portion 130 of the inner surface 138b forms a truncated cone with sides that define an angle Θ₂ with respect to the central axis C₂. The angle Θ₂ can be 5 degrees to 15 degrees, though other ranges for the angle Θ₂ are contemplated. The portion 130 can be tapered as such to provide space for the hub 120 to receive the adhesive 164, as will be described further below.

The body 124 of the hub 120 can also define two implementations of the radial features 144 extending radially into the body 124 from the inner surface 128b. As such, the radial features 144 can be recesses that extend into the body 24. Each of the radial features 144 can extend 360 degrees about the central axis C₂ and radially into the body 124 from the inner surface 128b. Each of the radial features 144 can substantially define a ring-shaped recess that extends 360 degrees about the central axis C₂. Though depicted as including two of the radial features 144, the body 124 can define more or less than two of the radial features 144. For example, the body 124 can define one, two, three, or four or more radial features 144. As shown, the body 124 of the hub 120 can include at least one of the radial features 144 that extends along a respective plane that is normal to the central axis C₂.

The dispense tip 100 can further include a tube 150 configured to be at least partially received within the passage 136 of the hub 120. The tube 150 can have a body 154 that defines a proximal end 154a and a distal end 154b opposite the proximal end 154a along the axial direction A. The body 154 can be comprised of a plastic, such as polypropylene, metal, such as stainless steel or a powdered metal, ceramic, such as zirconia toughened alumina, zirconia, silicon nitride, etc. The body 154 can also define an outer surface 158a and an inner surface 158b opposite the outer surface 158a along the radial direction R. As shown, the tube 150 can be substantially shaped as a cylindrical tube along its length with the exception of the distal end 154b, which can taper inwards so as to define a point. However, it is contemplated that the tube 150 can be tapered more or less at the distal end 154b in other embodiments, or can even define a completely non-tapered cylindrical tube. The tube 150 can define a central passage 162 extending therethrough from an inlet 162a to an outlet 162b opposite the inlet 162a along the axial direction A. When the tube 150 is received within the passage 136, particularly the third section 136c of the passage 136, the central passage 162 of the tube 150 is in fluid communication with the passage 136 of the hub 120, such that when the dispense tip 100 is attached to a material source, the material can flow from the material source, through the inlet 138a of the passage 136, through the first section 136a and the second section 136b of the passage 136, through the inlet 162a of the central passage 162, through the central passage 162 of the tube 150, and out the outlet 162b of the central passage 162 and onto a substrate.

During assembly, the hub 120 and the tube 150 must be joined together so that the tube 150 does not separate from the hub 120 during use. To do this, adhesive 164 can be disposed between the tube 150 and the inner surface 128b of the hub 120 to secure the tube 150 to the hub 120. The adhesive 164 can be a two-part epoxy, though other types of adhesives are contemplated, etc. In previous dispense tip embodiments, the bond between the hub and the tube created by the adhesive can weaken over time, leading material leaking out of the dispense tip or the tube completely separating from the hub. However, in the dispense tip 100, the presence of the radial feature 144 can strengthen the ability of the adhesive 164 to bond the hub 120 to the tube 150. Specifically, when the adhesive 164 is disposed between the tube 150 and the hub 120, the adhesive is received within the radial features 144. This allows the adhesive 164 to create a stronger grip with the hub 120, thus creating a stronger bond between the tube 150 and the hub 120. Over time, dispense tips 100 including the radial features 144 are able to withstand greater relative loads applied to one of the hub 120 and the tube 150 and undergo a greater number of cleaning cycles without the bond between the hub 120 and the tube 150 weakening or completely failing.

In addition to the adhesive 164, the dispense tip 10 can include a projection 148 and groove 166 configured to secure the hub 120 to the tube 150. The projection 148 can extend radially inwards from the inner surface 128b of the hub 120 and can have a substantially hemispherical cross-sectional profile along a plane parallel to the central axis C₂. The projection 148 in the depicted embodiment extends substantially around the entirety of the circumference of the inner surface 128b, though in other embodiments it is contemplated that the projection 148 can extend around only a portion of the inner surface 128b. The tube 150 can define a groove 166 that extends radially inward from the outer surface 158a of the tube 150 that is configured to receive and engage the projection 148 of the hub 120. When the groove 166 receives the projection 148, the tube 150 can be axially locked relative to the hub 120. Though one groove 166 and one projection 148 are shown, the dispense tip 100 can include more than one groove 166, as well as more than one corresponding implementation of the projection 148.

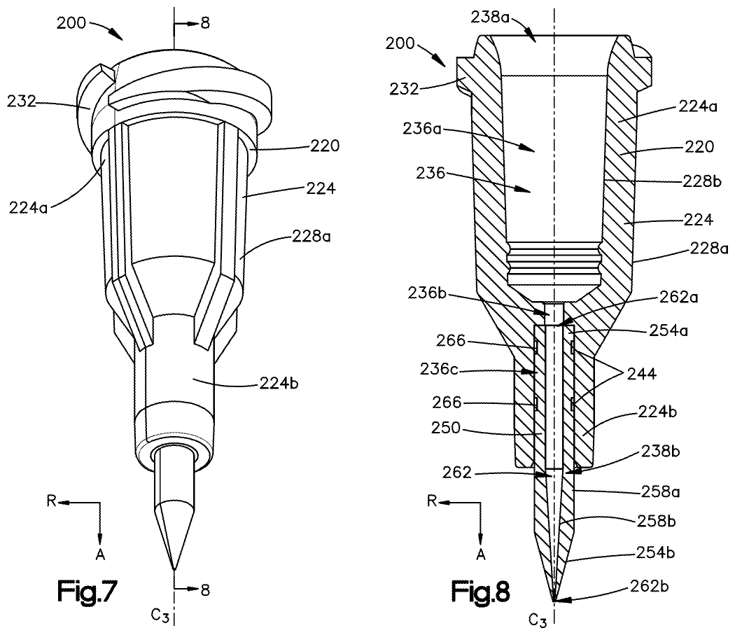

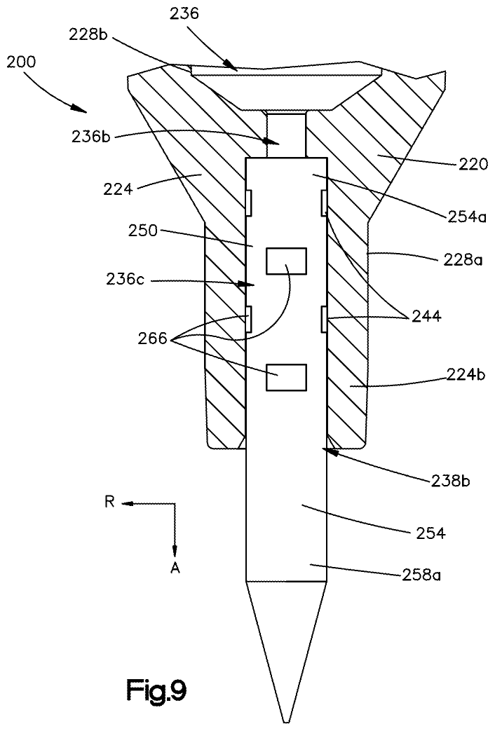

Now referring to FIGS. 7-9 a dispense tip 200 according to another embodiment of the present disclosure will be described. The dispense tip 200 can be configured to receive material from a material source and apply the material to a substrate, as will be described further below. The dispense tip 200 can include a hub 220 and a tube 250 secured to the hub 220, where each of the hub 220 and the tube 250 will be described in detail below. The hub 220 can comprise a body 224 that defines a proximal end 224a and a distal end 224b opposite the proximal end 224a along a central axis C₃ that is parallel to the axial direction A. The central axis C₃ can extend through the body 224 such that the central axis C₃ extends through the radial center of the body 224. The hub 220 can comprise a plastic, such as polypropylene, polyethylene, PEEK, etc. The hub 20 can also be comprised of a metal, such as stainless steel, though other metals are also contemplated. The body 224 can also define an outer surface 228a, and an inner surface 228b opposite the outer surface 228a along the radial direction R. The body 224 can include a thread 232 extending radially from the outer surface 228a of the body 224. The thread 232 can be configured to threadedly engage a material source, such as dispensing valve, dispensing pump, dispensing reservoir such as a barrel syringe, etc. Though thread 232 specifically is shown, the body 224 can include alternative means for engaging with a material source (not shown), such as snap-fit engagement, slot and groove attachment, bayonet attachment, etc.

The body 224 can further include a passage 236 extending through the body 224 from the proximal end 224a to the distal end 224b, such that the inner surface 228b faces the passage 236. The passage 236 can extend from an inlet 238a at the proximal end 224a of the body 224 to an outlet 238b at the distal end 224b of the body 224. The passage 236 can define multiple sections, particularly a first section 236a at the proximal end 224a of the body 224, third section 236c at the distal end 224b of the body 224, and a second section 236b that extends from the first section 236a to the third section 236c along the axial direction A.

The dispense tip 200 can further include a tube 250 configured to be at least partially received within the passage 236 of the hub 220. The tube 250 can have a body 254 that defines a proximal end 254a and a distal end 254b opposite the proximal end 254a along the axial direction A. The body 254 can be comprised of a plastic, such as polypropylene, metal, such as stainless steel or a powdered metal, ceramic, such as zirconia toughened alumina, zirconia, silicon nitride, etc. The body 254 can also define an outer surface 258a and an inner surface 258b opposite the outer surface 258a along the radial direction R. As shown, the tube 250 can be substantially shaped as a cylindrical tube along its length with the exception of the distal end 254b, which can taper inwards so as to define a point. However, it is contemplated that the tube 250 can be tapered more or less at the distal end 254b in other embodiments, or can even define a completely non-tapered cylindrical tube. The tube 250 can define a central passage 262 extending therethrough from an inlet 262a to an outlet 262b opposite the inlet 262a along the axial direction A. When the tube 250 is received within the passage 236, particularly the third section 236c of the passage 236, the central passage 262 of the tube 250 is in fluid communication with the passage 236 of the hub 220, such that when the dispense tip 200 is attached to a material source, the material can flow from the material source, through the inlet 238a of the passage 236, through the first section 236a and the second section 236b of the passage 236, through the inlet 262a of the central passage 262, through the central passage 262 of the tube 250, and out the outlet 262b of the central passage 262 and onto a substrate.

During production, the hub 220 and the tube 250 must be joined together so that the tube 250 does not separate from the hub 220 during use. Unlike the dispense tips 10, 100, the dispense tip 200 does not utilize any adhesive. Instead, the dispense tip 10 can include a plurality of radial features 244 and grooves 266 that are configured to secure the tube 250 to the hub 220. Specifically, a plurality of radial features 244 can extend radially inwards from the inner surface 228b of the body 224. As such, the radial features 244 can be projections that extend from the body 224. Each of the radial features 244 can substantially define a rectangular projection, though other shapes are contemplated. The radial features 244 can be staggered radially and axially along the inner surface 228b of the body 224, such that a particular arrangement of the radial features 244 is defined on the inner surface 228b. The body 224 can define two, three, four, five, six, or seven or more of the radial features 244 as desired. Each of the radial features 244 can engage a corresponding implementation of the groove 266 defined on the outer surface 258a of the tube 250. Each groove 266 can define a substantially rectangular shape that corresponds to the shape of the radial features 244. Further, the tube 250 can define any number of grooves 266, though the number of grooves 266 will generally correspond to the number of radial features 244 defined by the hub 220. To produce the dispense tip 200, after formation of the tube 250 the hub 220 can be injection molded about the tube 250 so as to form the radial features 244 within the grooves 266, which axially secures the hub 220 to the tube 250.

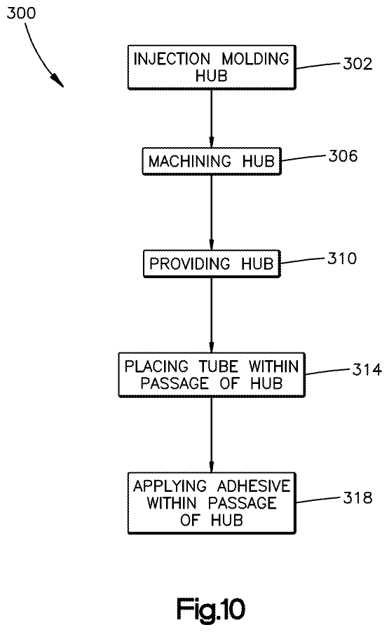

Now referring to FIG. 10, a method 300 of manufacturing the dispense tip 10 discussed above will be described. As stated previously, the dispense tip 10 can be configured to receive material from a material source and apply the material to a substrate. In step 302, method 300 can begin by injection molding a hub 20, 20′, 20″, 20′″. The method 300 can also include step 306, which includes machining the hub 20, 20′, 20″, 20′″ to form the at least three implementations of the radial features 44, 44′, 48. Then, step 310 can include providing the hub 20, 20′, 20″, 20′″ having a body 24 that defines a proximal end 24a, a distal end 24b opposite the proximal end 24a along the central axis C₁, a passage 36 extending through the body 24 from the proximal end 24a to the distal end 24b, an inner surface 28b facing the passage 36, and at least three implementations of the radial features 44, 44′, 48 extending 360 degrees about the central axis C₁ and radially into the body 24 from the inner surface 28b. Then, in step 314, method 300 can include placing a tube 50 defining a central passage 62 that extends therethrough at least partially within the passage 36 of the hub 20, 20′, 20″, 20′″ such that the central passage 62 is in fluid communication with the passage 36. Method 300 can further include step 318, which includes applying the adhesive 64 within the passage 36 of the hub 20, 20′, 20″, 20′″ between the tube 50 and the inner surface 28b of the hub 20, 20′, 20″, 20′″ to secure the tube 50 to the hub 20, 20′, 20″, 20′″.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts, and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features, and concepts may be expressly identified herein as being inventive or forming part of an invention, such identification is not intended to be exclusive, but rather there may be inventive aspects, concepts, and features that are fully described herein without being expressly identified as such or as part of a specific invention, the scope of the inventions instead being set forth in the appended claims or the claims of related or continuing applications. Descriptions of exemplary methods or processes are not limited to inclusion of all steps as being required in all cases, nor is the order that the steps are presented to be construed as required or necessary unless expressly so stated. While the invention is described herein using a limited number of embodiments, these specific embodiments are not intended to limit the scope of the invention as otherwise described and claimed herein. The precise arrangement of various elements and order of the steps of articles and methods described herein are not to be considered limiting.

1. A dispense tip configured to receive material from a material source and apply the material to a substrate, the dispense tip comprising:
a hub having a body that defines a proximal end, a distal end opposite the proximal end along a central axis, a passage extending through the body from the proximal end to the distal end, an inner surface facing the passage, and at least two radial features each extending at least partially about the central axis;
a tube defining a central passage extending therethrough, wherein the tube is configured to be at least partially received within the passage such that the central passage of the tube is in fluid communication with the passage of the hub; and
an adhesive disposed between the tube and the inner surface of the hub, wherein the adhesive is received within the at least two radial features and is configured to secure the tube to the hub.

2. The dispense tip of claim 1, wherein the body of the hub defines a sharp edge where at least one of the radial features extends from the inner surface.

3. The dispense tip of claim 1, wherein each of the radial features extends 360 degrees about the central axis.

4. The dispense tip of claim 1, wherein each of the radial features extends radially into the body from the inner surface.

5. The dispense tip of claim 1, wherein the radial features each have different heights along the central axis.

6. The dispense tip of claim 5, wherein:
the at least two radial features comprise a first radial feature, a second radial feature, and a third radial feature,
the first radial feature is proximal of the second radial feature and the second radial feature is proximal of the third radial feature, and
a height of the second radial feature is greater than a height of the first radial feature and the third radial feature.

7. The dispense tip of claim 1, wherein the radial features at least partially define a continuous helical thread.

8. The dispense tip of claim 7, wherein each of the radial features has a triangular profile along a plane parallel to the central axis.

9. The dispense tip of claim 7, wherein each of the radial features has a trapezoidal profile along a plane parallel to the central axis.

10. The dispense tip of claim 1, wherein each of the radial features extends along a respective plane that is normal to the central axis.

11. The dispense tip of claim 1, wherein at least one of the radial features extends along a respective plane that is normal to the central axis, and at least one of the radial features at least partially defines a continuous helical thread.

12. The dispense tip of claim 1, wherein the body of the hub defines at least one groove that extends radially into the body from the inner surface and along an axial direction parallel to the central axis from one of the radial features to another of the radial features.

13. The dispense tip of claim 1, wherein the body of the hub defines a protrusion extending into the passage from the inner surface, wherein the protrusion is axially positioned between the proximal end of the body and the radial features.

14. The dispense tip of claim 13, wherein the protrusion defines a helical thread.

15. The dispense tip of claim 13, wherein the protrusion extends along a plane that is normal to the central axis.

16. The dispense tip of claim 13, wherein the body defines at least one groove that extends through the protrusion and along an axial direction parallel to the central axis.

17. The dispense tip of claim 1, wherein the body defines at least four radial features.

18. The dispense tip of claim 1, wherein the tube comprises stainless steel, ceramic, or plastic.

19. The dispense tip of claim 1, wherein the adhesive comprises a two-part epoxy.

20. A method of manufacturing a dispense tip configured to receive material from a material source and apply the material to a substrate, the method comprising:
providing a hub having a body that defines a proximal end, a distal end opposite the proximal end along a central axis, a passage extending through the body from the proximal end to the distal end, an inner surface facing the passage, and at least two radial features each extending at least partially about the central axis;
placing a tube defining a central passage extending therethrough at least partially within the passage such that the central passage of the tube is in fluid communication with the passage of the hub; and
applying an adhesive within the passage of the hub between the tube and the inner surface of the hub to secure the tube to the hub.

21. The method of claim 20, further comprising injection molding the hub.

22. The method of claim 21, further comprising machining the hub to form the at least two radial features.
